(19) United States
(12) Patent Application Publication
(10) Pub. No.: US 2020/0098040 A1
(43) Pub. Date: Mar. 26, 2020

(54) FLEXIBLE LOAN MANAGEMENT SYSTEM AND METHOD

(71) Applicants: David BEN-NATAN, Yehud (IL); Yossef YARKONI, Givaataim (IL)

(72) Inventors: David BEN-NATAN, Yehud (IL); Yossef YARKONI, Givaataim (IL)

(21) Appl. No.: 16/136,471

(22) Filed: Sep. 20, 2018

(51) Int. Cl. G06Q 40/02

(52) U.S. Cl. CPC G06Q 40/025

(57) ABSTRACT

A method for managing loans and loans repayments in a way that allows an individual borrower to provide flexible and variable repayments to one or more lenders, comprising a) generating a personalized loan repayments range for said individual borrower out of which said individual borrower is able to select a specific repayment amount for an upcoming repayment, thereby enabling to receive varied loan repayments; and/or b) enabling to adjust the personalized loan repayments range for at least one upcoming repayment period according to the deviation from the range's average of previous repayments as provided by said individual borrower among plurality of other individual borrowers in one or more previous repayments periods.

### FIELD OF THE INVENTION

The present invention relates to the field of financing and refinancing. More particularly, the invention relates to a system for managing loans and loan repayments.

### BACKGROUND OF THE INVENTION

Typical loan schemes involve at least one loaner (lender) consenting to loan a specific amount of money to a single loanee (borrower) and the latter committing to repay the amount of money to the lender. Most lenders, even those motivated by good will and philanthropy, require background information of the borrower before approving a loan in order to ensure repayment according to an expected rate and timetable.

Borrowers, on the other hand, are often interested in repaying according to their financial capabilities which, in many cases, varies from time to time, but unfortunately they don't have such an actual possibility. This is usually unacceptable to lenders due to their abovementioned expectations. In many cases part of the loan contracts that are signed between a lender and a borrower allows the lender to impose fines or increased interest on a borrower that fails to repay on time and therefore imposing more of a financial difficulty on the borrower.

It would be advantageous to have a system and method allowing all participating parties to customize their contribution in order to suit their preferences and capabilities. Specifically it would be advantageous to have a system and method ensuring lenders control over their repayment depending on their preferences while allowing borrowers flexible and variable repayments depending on their varying financial capabilities. It is therefore an object to provide such a system and method.

Other objects and advantages of the invention will become apparent as the description proceeds.

### SUMMARY OF THE INVENTION

A method for managing loans and loans repayments in a way that allows an individual borrower to provide flexible and variable repayments to one or more lenders, comprising:
a) generating a personalized loan repayments range for said individual borrower out of which said individual borrower k able to select a specific repayment amount for an upcoming repayment, thereby enabling to receive varied loan repayments; and/or
b) enabling to adjust the personalized loan repayments range for at least one upcoming repayment period according to the deviation from the range's average of previous repayments as provided by said individual borrower among plurality of other individual borrowers in one or more previous repayments periods.

According to an embodiment of the invention, the adjustment of the personalized loan repayments range for each individual borrower enables to manage the received varied loan repayments in order to generate a fixed total average repayment for the one or more lenders, and to provide a total aggregated fixed repayment for each lender.

According to an embodiment of the invention, the generation of a fixed total average repayment comprising distributing the borrowers into several portions (up to the number of borrowers) to ensure that the portions' average repayment of each individual borrower will sum up to the overall repayment that is expected, and using a behavioral module to predicts one or more individual borrowers who are less probable to deviate from the average repayment amount in order to balance the expected total repayment due for each period.

According to an embodiment of the invention, the method further comprising flattening the repayments gathered from different individual borrowers in various loans to the same predicted aggregated sum that each lender is expecting to receive.

According to an embodiment of the invention, the method further comprising distributing loans from a plurality of lenders among a plurality of borrowers and providing loans to said borrowers from said lenders, while enabling said borrowers to repay loans according to each borrower's preferences and enabling said lenders to receive repayments, according to each lender's preferences.

According to an embodiment of the invention, a blockchain-based smart contract is used to maintain loans transactions in order to enable flexible and variable repayments to the one or more lenders, while creating total transparent environment for said one or more lenders, keeping exact record of all repayments and the split of each one of them between the lenders.

According to an embodiment of the invention, the blockchain-based smart contract enables to eliminate any trust issues between different lenders as for their portion in the variable repayment.

According to an embodiment of the invention, the blockchain-based smart contract receives transaction verifications from a third party.

According to an embodiment of the invention, the method further comprising;
a) providing a plurality of lender profiles, each profile including details and loan preferences of a lender;
b) providing, a plurality of borrower profiles, each profile including details and loan preferences of a borrower; and
c) comparing the profiles for finding matches between borrowers and lenders according to the profiles of each.

In another aspect, a loan management system configured to distribute loans from a plurality of lenders among a plurality of borrowers and to provide loans to said borrowers from said lenders, wherein the borrowers repay loans according to each borrower's preferences and wherein the lenders receive repayments according to each lender's preferences, while on the aggregates the loans repayments will sum up to the exact expected total amount.

According to an embodiment of the invention, the system distributes the borrowers into several portions ensuring that the portions' average will sum up to the overall repayment that is expected by each lender.

According to, an embodiment of the invention, a blockchain based smart contract is used to manage the loans.

According to an embodiment of the invention, a borrower receives a loan from one or more lenders.

According to an embodiment of the invention, a borrower may receive a loan from a plurality of lenders, including the possibility of having nonprofit or philanthropic organization becoming lender/s in that same loan to reduce the average loan interest.

According to an embodiment of the invention, a lender loans a plurality of borrowers.

According to an embodiment of the invention, the lenders' preferences are chosen from a list comprising: a principal amount of money, interest rate, date of repayment, rate of repayment, loan purpose, or any combination thereof.

According to an embodiment of the invention, the borrowers' preferences are chosen from a list comprising: a principal amount of money, interest rate, date of repayment, rate of repayment, loan purpose, or any combination thereof.

According to an embodiment of the invention, the lenders are chosen from a list comprising: banks, philanthropists, philanthropic funds, insurance companies, industrial corporations, or any combination thereof.

According to an embodiment of the invention, the system further comprising a funds reserve through which funds are transferred between the lenders and the borrowers.

In another aspect, the invention relates to a method for managing loans in a way that allows different borrowers flexible and variable repayments to lenders, comprising:
a) distributing the borrowers into several portions to ensure that the portions' average repayment of each borrower will sum up to the overall repayment that is expected;
b) presenting for each borrower a range of sums from which said borrower is able to select a sum for an upcoming repayment;
c) collecting the selected sum from the borrower's bank; and
d) flattening the repayments gathered from different borrowers in various loans to the same predicted aggregated sum that each lender is expecting to receive.

According to an embodiment of the invention, the method comprising distributing loans from a plurality of lenders among a plurality of borrowers and providing loans to said borrowers from said lenders, while enabling said borrowers to repay loans according to each borrower's preferences and enabling said lenders to receive repayments according to each lender's preferences.

### BRIEF DESCRIPTION OF THE DRAWINGS

in the drawings:

FIG. 1 schematically illustrates a system for managing loans, according to an embodiment;
FIG. 2 schematically illustrates a loan management server of the system, according to an embodiment of the invention;
FIG. 3 shows a flowchart of a method for managing loans, according to an embodiment;

FIG. 4 shows a simplified schematic overview of the system for managing loans, according to an embodiment of the invention.

### DETAILED DESCRIPTION OF THE INVENTION

Reference will now be made to an embodiment of the present invention, examples of which are provided in the accompanying figures for purposes of illustration only. One skilled in the art will readily recognize from the following description that alternative embodiments of the structures and methods exemplified herein may be employed, mutatis mutandis, without departing from the principles of the invention.

Disclosed is an automated ad hoc syndicate method for managing loans that may involve a plurality of lenders and investors with different terms and conditions that are acquired automatically. Accordingly a lender defines criteria for loaning (e.g. forgiveness amount, grace period, requested interest and/or other preferences associated with the loan or borrower) in order for someone to eligibly loan money therefrom. A lender profile is created for each lender including lender details, terms and conditions, and any other parameters that may be relevant to funding a loan. Exemplary and non-limitative lenders include banks, philanthropists arid philanthropic funds, insurance companies and industrial corporations.

Similarly, an individual applying for a loan (a borrower) is required to provide information that may affect the loan (e.g. the purpose of the loan, financial and personal background), in addition to granting access to resources from which certified information regarding the borrower may be collected (e.g. financial background, credit reports, social networks, etc.). Borrower profiles are created with these details.

Generally, lenders are usually interested in investing an amount of money regardless of the number of borrowers who benefit from their money. In addition lenders are usually interested in receiving money, regardless of the number of lenders to whom the money is repaid, as long as the overall repayment conditions suit their financing capabilities. According to an embodiment, lender money may be split between a plurality of borrowers who meet the conditions by means of a comparison system based on matching criteria, comparison algorithms and building profiles on the basis of data collection by the same online system.

Specifically, the comparison system is configured to receive a plurality of borrower profiles and a plurality of lender profiles. The comparison system matches between borrowers and lenders. The system compares between the terms and conditions in the lender profiles and the properties and capabilities in the borrower profiles sows to provide a loan to each of the borrower's that is most suitable to each of their profiles and repayment capabilities while ensuring repayment to each of the lenders according to each of their profiles. Exemplary non-limitative parameters that are considered and, compared include:
the principal amount of money loaned;
the interest rate;
the date of repayment; and
the rate of repayment.

While the inconsistency of these parameters is usually a drawback in traditional loaning systems and schemes, this property of inconsistency is exploited to maximum so as to ensure each of the lenders that they receive their repayment according to their desired rate and timetable while allowing each of the borrowers to determine a specially tailored repayment plan according to their financial capabilities which may even change over the time of the repayment.

Once a match is found between a lender and a borrower, a blockchain-based smart contract is generated and certified and that holds the lenders loaning criteria, the borrower's profile and the loan terms.

After a match between a borrower and lender/s is found and an agreement is signed by the borrower, a smart contract is generated that comprises borrower details such as the loan terms & conditions, the amount each lender contributed (i.e., the portions), etc. The system than sends a notification every month to enable the borrower to choose a specific amount out of a personalized range. This amount is charged to his bank account between the different lenders is registered confirmed.

According to an embodiment, a loan can be diversified to a plurality of lenders. Some of the lenders may include, philanthropic elements with forgiveness or long grace periods which reduce the overall cost of the loan resulting in lower risk to the financial institutions and thereby improving the borrower's credit score continuously over the period of the loan. The control system provides lenders full control over the sums already distributed from the total fund allocated, and the terms that were matched, with two-way messaging to enable communication between the lender and borrower. Similarly, a loan can be distributed among a plurality of borrowers, i.e. each lender loans and is repaid from more than one borrower, thereby increasing the capability of repayment meeting the lenders' expectations.

According to an embodiment funds are transferred from between parties via a funds reserve that comprises incoming and outgoing money routes to each of the borrowers and lenders and a money reserve. Money may be accumulated in the reserve so as to ensure that all parties receive their expected repayment plans, for instance in cases of temporary financial incapability of the borrowers to collectively meet the repayment requirements. In some embodiments an initial amount of money is deposited in the reserve so as to ensure that all lending parties receive their expected repayments, e.g. in case the borrowers aren't capable of collectively meeting the required repayment amount.

A software program runs an algorithm that streamlines money flow of borrowers' repayments using data gathered from different borrowers in various loans, to the same predicted aggregated sum that the lender (e.g. a bank) is expecting to receive if all the loans would have been paid with constant repayments. The software algorithm presents for each borrower a range of sums from which he may choose a sum for an upcoming repayment. The borrower indicates the specific sum within this limit and the system collects the sum from the borrower's bank and transfers the money to the lenders (in the relevant embodiments, via the funds reserve).

In order to avoid substantial deviation in loan repayments frauds, the system may involve one or more of the following factors on each recurring repayment:
1. A personal module that ensures that the borrower will remain as close to the average payment schedule as possible over a long period of time that in the long run ensures that would be compensated in the future.
2. A group module that distributes the borrowers into several portions (up to the number of borrowers) ensuring that the portions' average will sum up to the overall repayment that is expected.
3. A behavioral module that predicts those borrowers who are less probable to deviate from the average repayment amount (as determined by the personalized range of those borrowers) in order to balance the exact total repayment due for each period.

Embodiments of the invention allow the behavioral module to generate models for predicting repayments of borrowers of the loan management system. For example, the loan management system of the present invention may use a model to predict whether a borrower is likely to provide the average repayment amount (i.e., those who will, not deviate from the average repayment amount). These models are also referred to herein as predictors. The system of the present invention uses the predictors to balance the exact total repayment due for each period. According to various aspects of the present invention, the behavioral module may reside on a server, an electronic device, or another suitable entity having sufficient processing capabilities to conduct behavioral analysis.

Crowd wisdom, along with a gradual approach within the control system, provides lenders full control over the funds expected by defining and monitoring the forecasted repayments. A lender may change the “managed range” of the last portions, and thereby the sum will be aggregated to the desired amount. Accordingly, the algorithm flattens the repayments gathered from different borrowers in various loans to the same predicted aggregated sum that each lender is expecting to receive.

The following discussions are intended to provide a brief, general description of a suitable computing environment in which the invention may be implemented. While the invention will be described in the general context of program modules or codes that execute in conjunction with an application program that runs on an operating system on a computer system, those skilled in the art will recognize that the invention may also be implemented in combination with other program modules. The functions described herein may be performed by executable code and instructions stored in computer readable medium and running on one or more processor-based systems. Embodiments of the invention may be implemented as a computer process, e.g., a computer system that encodes a computer program of instructions for executing the computer process.

FIG. 1 schematically illustrates a system 100 for managing loans between plurality of lenders and borrowers, according to an embodiment. System 100 comprises a blockchain-based smart contract allocator 11 that can be implemented as part of a loan management senior 10. The system's server 10 is configured to communicate at one end with a plurality of lenders' financial systems, such as banks, corporations, philanthropists, insurance companies, etc., and on the other end, server 10 is configured to communicate with a plurality of borrowers. In this figure, the borrowers are schematically indicated by numerals 1-6, the banks are indicated by B1, B2 and B3, a corporation is indicted by C1, and the philanthropists are indicated by P1 and P2. Loan management server 10 is configured to generate a personalized loan repayment range for each individual borrower (herein a personalized range) that can be dynamically adjust for each upcoming repayment period according to the repayment amount provided by the individual borrower in previous period(s), to receive varied loan repayments from each borrower according to the limits of the loan repayment range (i.e., one may select the repayment amount within its personalized range between a given minimum to a maximum amount, for example, a personalized range of a specific borrower can be set to 800$-1200$ thus the borrower may selected whether to pay the average sum of 1000$ or any other amount that does not deviate the range's limits, i.e., in this example, no less than 800$ or no more than 1200$), to manage the received varied loan repayments in order to generate a fixed total average repayment for each lender, and to provide a total aggregated fixed repayment for each lender. Loan management server 10 enables each borrower to provide varied loan repayments that are within the personalized range via any suitable source (e.g., via borrowers' terminal devices such as smartphones, web-based applications, websites, bank transfer or any other suitable payment transfer arrangement).

For example, as schematically illustrated in this figure, smart contract allocator 11 provides the following loan allocation among matched borrowers 1-6 and lenders B1-B3, C1 and P1-P2.

In this specific example, the borrowers 1-6 obtain their loan as follows, while each lender maintains its own terms and interest (e.g., Bank B1 provides loans with 5% interest, Bank B2 provides loans with 4.5% interest, Bank B3 provides loans with 4.4% interest, Corporation C1 provides loans, with 0% and the philanthropic sources P1 and P2 provide loans with negative interests):
Borrower 1 obtains 40% of the loan from bank B1 and 60% of the loan from philanthropic source P2, as indicated by smart contract 1 (SC1) in the figure;
Borrower 2 obtains 25% of the loan from bank B2, 25% of the loan from philanthropic source P1, and 50% of the loan from bank B3, as indicated by smart contract 2 (SC2) in the figure;
Borrower 3 obtains 10% of the loan from bank B3, 60% of the loan from philanthropic source P2, and 30% of the loan from bank B1, as indicated by smart contract 3 (SC3) in the figure;
Borrower 4 obtains 40% of the loan from corporation C1, and 60% of the loan from philanthropic source P1, as indicated by smart contract 4 (SC4) in the figure;
Borrower 5 obtains 100% of the loan (i.e., the entire loan) from bank B1, as indicated by smart contract 5 (SC5) in the figure; and
Borrower 6 obtains 10% of the loan from bank B1, 50% of the loan from bank B2, and 40% of the loan from bank B3, as indicated by smart contract 6 (SC6) in the figure.

As can be easily seen in the figure, each lender loans only matched borrowers, e.g., bank B1 provides loans to lenders 1, 3, 5 and 6, bank B2 only to borrowers 2 and 6, bank 3 only to borrowers 2, 3 and 6, corporation C1 to borrower 4, philanthropic source P1 to borrowers 2 and 4, and philanthropic source P2 to borrowers 1 and 3, etc.

FIG. 2 schematically illustrates the modules of loan management server 10, according to an embodiment of the invention. Loan management server 10 comprises the blockchain-based smart contract allocator 11, a loan repayments range generator 12, a matching allocator 13, a processing unit 14, a database 15, a communication module 16 and a behavioral module 17. While certain references are made to certain example system components or modules, other components and modules can be used as well and/or the example modules can be combined into fewer modules and/or divided into further modules. For example, blockchain-based smart contract allocator 11 and matching allocator 13 can be implemented and/or integrated into one component, the aforementioned personal module and group module can be integrated into the loan repayments range generator 12 or behavioral module 17. Moreover, unless otherwise indicated, the functions of the different modules and the predictors described herein may be performed by executable code and instructions stored in computer readable medium and running on one or more processor-based systems, such as processing unit 14. However, state machines, and/or hardwired electronic circuits can also be utilized. Further, with respect to the example processes described herein, not all the process states need to be reached, nor do the states have to be performed in the illustrated order. Further, certain process states that are illustrated as being serially performed can be performed in parallel.

According to an embodiment of the invention, as the blockchain-based smart contract of system 100 is used as a private blockchain-based smart contract, loan management server 10 may further comprise a transaction verification module 18 in order to ensure credible transactions. The private blockchain-based smart contract is a computer protocol intended to digitally facilitate the performance of a contract. In order to ensure credible transactions, transaction verification module 18 allows the performance of credible transactions via one or more third parties that provide audit services (e.g., via an insurance node that provides verification to the transaction). The third party independently verifies the transaction (i.e., in the “real world”—offline the blockchain) and provides verifications to the blockchain transaction verification module 18. For example, blockchain-based smart contract allocator 11 and transaction verification module 18 can be implemented and/or integrated into one component. In other words, the blockchain-based smart contract of the present invention may receive transaction verifications from a third party.

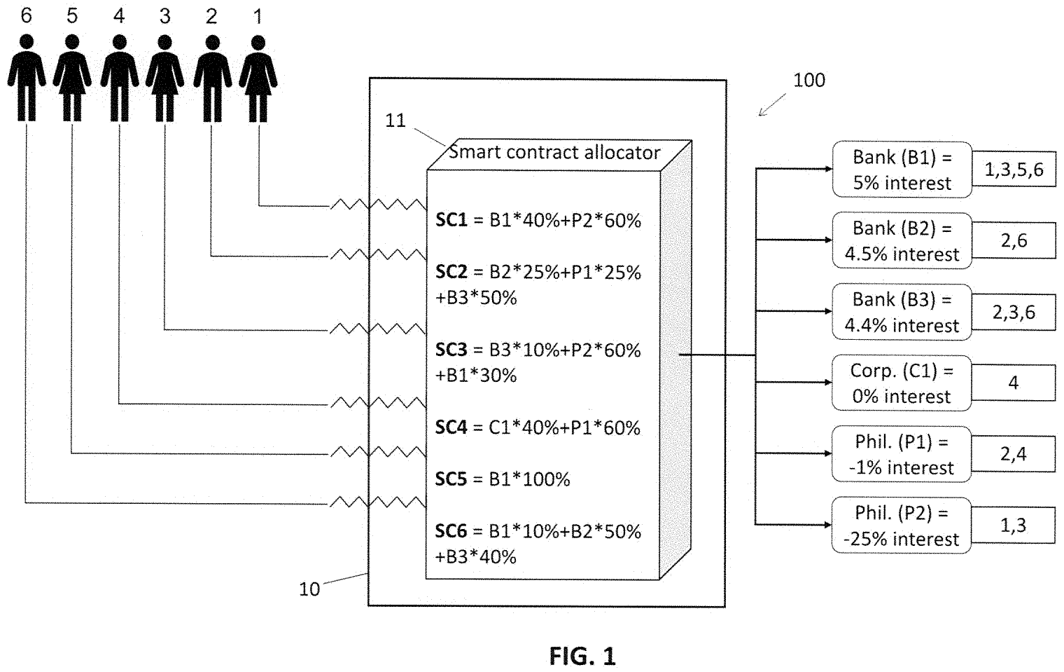

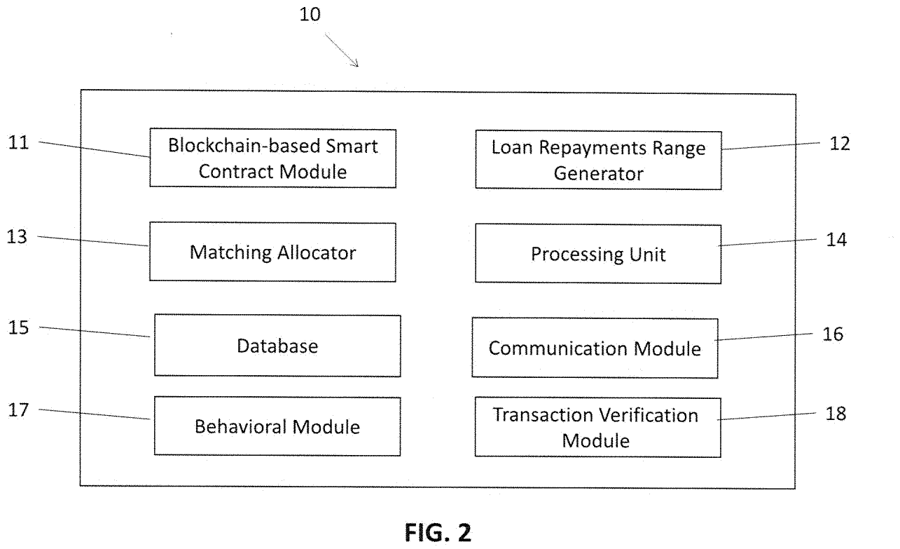

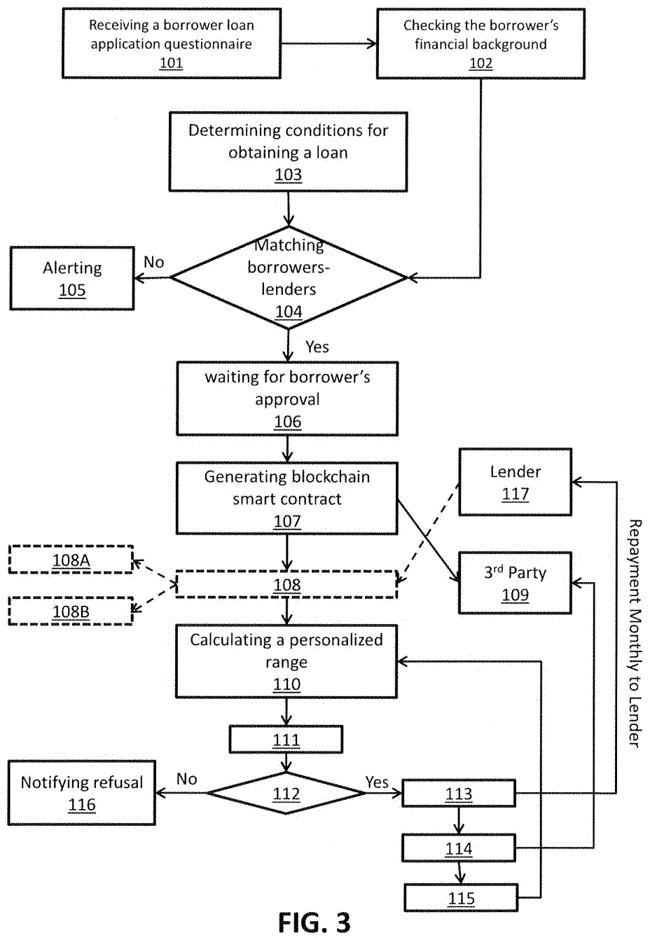

FIG. 3 shows a flowchart of a method for managing loans, according to an embodiment. A borrower fills a borrower loan application questionnaire in which the borrower's personal and financial details are inserted in addition to the desired loan amount. Accordingly, the system receives the borrower loan application questionnaire (bloc 101). A financial background surveyor checks the borrower's financial background from a plurality of sources (bloc 102), as detailed hereinabove. A plurality of lenders fill lender loan forms, determining the total amount of funding, conditions for obtaining a loan from the funding (including repayment terms and conditions) and who the loan is designated to (bloc 103). Forms such as the survey checks and lender loan forms are sent to the matching allocator 13 (FIG. 2) configured to compile a syndication of borrowers with different lenders and investors with different terms and conditions (bloc 104).

If not match is found for a borrower or for a lender then an alert is sent to an administrator of the system (bloc 105). if a match between a borrower and a lender is found the system produces standard forms of each lender, and sends the appropriate forms to the borrower for signing and waiting for borrower's approval (bloc 106). Upon borrower approval, a blockchain-based smart contract is generated, registering the lender's lending criteria, the borrower's financial background check, the loan terms and loan application forms, and is certified by a smart contract certification system (bloc 107). In some embodiments of the invention, a third party assurance node is issued (such as the abovementioned funds reserve) so as to assure fund transfer (bloc 109). Once the smart contract is certified, a transaction for early repayment of the total amount (i e,, a one-time repayment as schematically indicated by the dotted lines in the figure) due to existing loan from money transfer account is made (bloc 108), in which case the existing loan is closed (bloc 108A) or the money is being transferred to the relevant institution, such as to an academic institution (bloc 108B).

A personalized range is calculated by the system for the borrower's repayment with an automatic default payment that is within the range (bloc 110). The borrower decides whether to actively choose an amount within the range or to automatically pay the default payment, after which a payment instruction is sent to the borrower's bank (bloc 111), The bank decides whether to authorize the transaction (bloc 113) in which case the money is transferred to the lender (bloc 117) and the transaction is registered and added to the blockchain (114). After payment, the system calculates and creates a new loan repayment taking into account the currently repaid fund (bloc 115). The third party is also notified that the repayment has been performed (bloc 109). If at bloc 112 the borrower's bank decides not to authorize the transaction then the lenders are notified about the refusal (bloc 116).

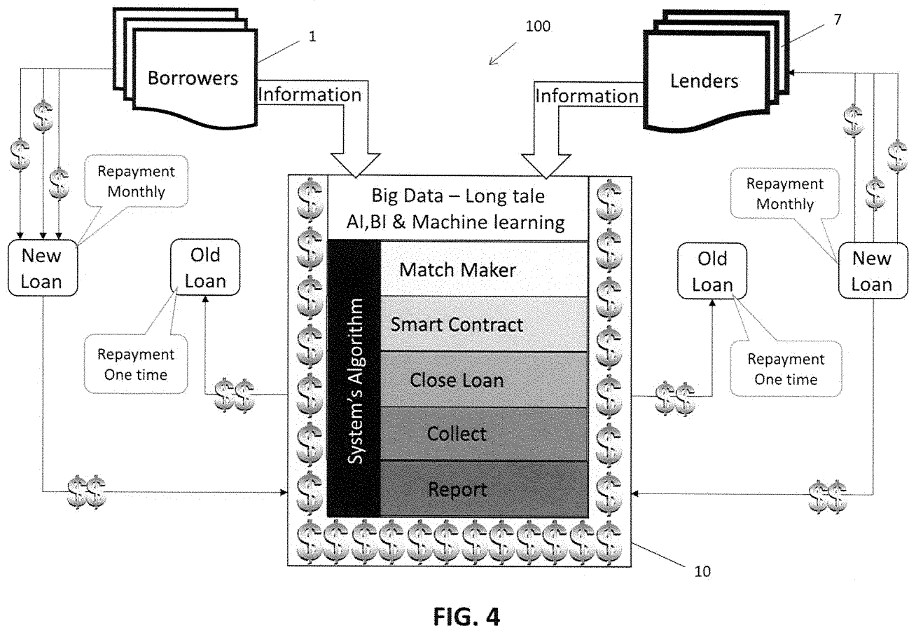

FIG. 4 shows a schematic overview of system 100 for managing loans, according to an embodiment of the invention. Data regarding borrowers 1 and lenders 7 is provided to server 10. Server 10 may aggregate the information and accordingly can be utilized as a big data source, thus different algorithms can be applied to the data, such as machine learning, artificial intelligent (AI) algorithms, behavioral analysis, etc. Such algorithms can be used to extract useful information regarding the predict repayments of the borrowers in order to enhance the operation of server 10, e.g., for automatically setting the personalized range of repayments and to balance the expected total repayment due for each period.

Although embodiments of the invention have been described by way of illustration, it will be understood that the invention may be carried out with many variations, modifications, and adaptations, without exceeding the scope of the claims.

1. A method for managing loans and loans repayments in a way that allows an individual borrower to provide flexible and variable repayments to one or more lenders, comprising:
a) generating a personalized loan repayments range for said individual borrower out of which said individual borrower is able to select a specific repayment amount for an upcoming repayment, thereby enabling to receive varied loan repayments; and
b) enabling to adjust the personalized loan repayments range for at least one upcoming repayment period according to the deviation from the range's average of previous repayments as provided by said individual borrower airing plurality of other individual borrowers in one or more previous repayments periods.

2. A method according to claim 1, wherein the adjustment of the personalized loan repayments range for each individual borrower enables to manage the received varied loan repayments in order to generate a fixed average repayment for the one or more lenders, and to provide a total aggregated fixed repayment for each lender.

3. The method according to claim 2, wherein the generation of a fixed total average repayment comprising distributing the borrowers into several portions, up to the number of borrowers, to ensure that the portions' average repayment of each individual borrower will sum up to the overall repayment that is expected, and using a behavioral module to predicts one or more individual borrowers who are less probable to deviate from the average repayment amount in order to balance the expected total repayment due for each period.

4. The method according to claim 3, further comprising flattening the repayments gathered from different individual borrowers in various loans to the same predicted aggregated sum that each lender is expecting to receive.

5. The method according to claim 1, further comprising distributing loans from a plurality of lenders among a plurality of borrowers and providing loans to said borrowers from said lenders, while enabling said borrowers to repay loans according to each borrower's preferences and enabling said lenders to receive repayments according to each lender's preferences.

6. The method according to claim 1, wherein, a blockchain-based smart contract is used to maintain loans transactions in order to enable flexible and variable repayments to the one or more lenders, while creating total transparent environment for said one or more lenders, keeping exact record of all repayments and the split of each one of them between the lenders.

7. The method according to claim 6, wherein the blockchain-based smart contract enables to eliminate any trust issues, between different lenders as for their portion in the variable repayment.

8. A method according to claim 6, wherein the blockchain-based smart contract receives transaction verifications from a third party.

9. The method according to claim 1, further comprising;
a) providing a plurality of lender profiles, each profile including details and loan preferences of a lender;
b) providing a plurality of borrower profiles, each profile including details and loan preferences of a borrower; and
c) comparing the profiles for finding matches between borrowers and lenders according to the profiles of each.

10. A loan management system configured to distribute loans from a plurality of lenders among a plurality of borrowers and to provide loans to said borrowers from said lenders, wherein the borrowers repay loans according to each borrower's preferences and wherein the lenders receive repayments according to each lender's preferences.

11. A loan management system according to claim 10, wherein the borrowers are distributed into several portions, up to the number of borrowers, ensuring that the portions' average will sum up to the overall repayment that is expected by each lender.

12. A loan management system according to claim 10, wherein a blockchain based smart contract is used to maintain the loans, the repayments and the transaction history.

13. A loan management system according to claim 10, wherein a borrower receives a loan from a plurality of lenders, including the possibility of having nonprofit or philanthropic organization becoming lender/s in that same loan to reduce the average loan interest.

14. A loan management system according to claim 10, wherein a lender loans a plurality of borrowers.

15. A loan management system according to claim 10, wherein the lenders' preferences are chosen from a list comprising:
a) a principal amount of money;
b) interest rate
c) date of repayment;
d) rate of repayment;
e) loan purpose; or
f) a combination of two or more of the above.

16. A loan management system according to claim 10, wherein the borrowers' preferences are chosen from a list comprising:
a) a principal amount of money;
b) interest rate
c) date of repayment;
d) rate of repayment;
e) loan purpose; or
f) a combination of two or more of the above.

17. A loan management system according to claim 10, wherein the lenders are chosen from a list comprising:
i. banks;
ii. philanthropists;
iii. philanthropic funds;
iv. insurance companies;
v. industrial corporations; or
vi. a combination of two or more of the above.

18. A loan management system according to claim 10, comprising:
a) a plurality of lender profiles, each profile including details and loan preferences of a lender;
b) a plurality of borrower profiles, each profile including details and loan preferences of a borrower; and
c) a comparison system for finding matches between borrowers and lenders according to the profiles of each.

19. A loan management system according to claim 10, further comprising a funds reserve through which funds are transferred between the lenders and the borrowers.
